(19) United States
(12) Patent Application Publication
(10) Pub. No.: US 2006/0009988 A1
(43) Pub. Date: Jan. 12, 2006

(54) Method, apparatus, data structure and system for determining lot sizes consistent with an entity's strategic objectives

(75) Inventor: John K. McCormick, West Bend, WI (US)

Correspondence Address: JOHN K. MCCORMICK, 6781 GLACIER DRIVE, WEST BEND, WI, 53090, US

(73) Assignee: Strategic Foresight LLC, West Bend, WI (US)

(21) Appl. No.: 10/710,384

(22) Filed: Jul. 6, 2004

(51) Int. Cl. G06Q 99/00

(52) U.S. Cl. 705/1

(57) ABSTRACT

A method, apparatus, data structure and system are disclosed for developing order and/or lot sizes for an entity that are consistent with and supportive of an entity's strategic objective. The disclosed process uses the chosen units of measure of the strategic objective to evaluate the total impact each job has on the strategic objective and then develops the order and/or lot sizes based upon the equalizing the total impact the job has on the strategic objective, less any fixed impact the job may have on the strategic objective, against the individual impact a single unit of the order or job has on the strategic objective.

### SUMMARY OF INVENTION

Generally, a method and apparatus are disclosed for determining order and/or lot sizes that are consistent with and supportive of an entity's strategic objective. The disclosed invention utilizes the units of measure of the strategic objective measure to determine the point of equilibrium between the total impact a given job and/or part order has on the strategic objective over a predetermined planning time frame and on the individual impact the job and/or part order has on the strategic objective. The determination of the point of equilibrium between these two values results in the determination of the order size and/or lot size, for a given job and/or order, that minimizes the total impact of the job and/or order on the strategic objective thereby maximizing and supporting the primary strategic objective.

As such, the present invention creates a new and useful means for directly linking an entity's strategic objectives to the daily activity of establishing the order and/or lot sizes when the strategic objective is something other than reducing costs. Therefore, this invention enables an entity to establish the appropriate order and/or lot sizes consistent with the strategic objective when the strategic objective is such activities as reducing lead-times, or increasing EBIT, or increasing sales, or a host of other primary strategic objectives other than keeping costs low.

As this invention provides for a variety of means for determining a given lot size and or order size based upon an entity's strategic objective, this enables the entity to change the determination of the appropriate lot and/or order sizes as the strategic objectives change over time. The long term result is a means to assure that the current order and/or lot sizes are always consistent with and maximizing the most current strategic objective that an entity has in place.

### BACKGROUND ART

In order to effectively manage and lead a business, whether it is a for-profit or non-profit entity, many entities develop strategic and/or operational plans. A strategic plan is primarily a list of key objectives an entity desires to pursue and achieve in order to survive, build and grow their business. The format and objectives created in a strategic plan varies from entity to entity based upon many factors, including their available resources, market knowledge, competition, and a host of other variables. Each entity decides what and how it wants to do strategic planning. In addition, the entity determines what their key objectives are. These key objectives are usually defined as goals or targets that an entity believes will improve their business if the objectives are achieved.

These objectives can encompass a wide variety of subject matter. For example, there may be objectives to improve profitability, to improve safety, to reduce lead-times for deliverable products or services, to improve customer satisfaction, to add more products, to increase market territory, to be environmentally conscious, or a host of other objectives as defined by the entity.

In addition to strategic planning, most entities develop operational plans, although it is possible to develop operational plans with no strategic plan in place and vise versa. In general, operational plans are typically done by subdivisions or departments within the entity. For example, an entity may have an overall strategic objective to increase revenue by ten percent. To support this goal, sales may have a goal of increasing sales revenue by ten percent, manufacturing may have a goal to improve operating productivity by five percent and purchasing may have a goal to reduce purchasing costs by five percent. Thus, each department will develop its own independent departmental goals in support of the overall strategic objectives.

These departmental goals are typically refined further with action items and detailed plans that layout the specifics of how the various departments are going to try and achieve their specific departmental goals. Sales may have a plan to implement a new marketing approach or a new sales promotion, manufacturing may have plans to improve manufacturing methods or add improved equipment, purchasing may have plans to target certain suppliers or new suppliers for cost reductions, or a host of other activities and plans.

Once the strategic and operational plans are approved, the entity begins the implementation of the various operational plans and typically monitors the progress and results of these actions relative to the operational plans and to the strategic objectives. While there are many possible time frames in which to monitor a company's progress, it is most often done on a monthly or quarterly review schedule.

While all of the strategic and operational activity is occurring, the rest of the business and organization continues doing business and work as it was done in the past. Today, almost every business uses some kind of computerized Management Information System (MIS) to manage and communicate information between the customers, suppliers, management and workers. In a very broad and general description, a business will have databases for the sales history and incoming orders, financial databases, engineering and design databases, material availability and inventory databases, human resources databases, production data bases, maintenance databases and a wide variety of other databases.

These databases are utilized by software resident in the MIS to track and provide information in a formatted method such that the people utilizing the formatted data can analyze the information and take action. For example, the purchasing and inventory control people can access reports showing the current levels of on-hand inventory and the forecasted usage of the same material. Based upon this information the purchasing people can choose to order more material or not. Similarly, sales can access the current status of on-hand finished goods and/or production schedules and utilize that information to inform customers of expected delivery dates. Management and accounting can access financial data to view the current financial condition of the entity and/or future estimates. Other departments can, and do, get information relative to their areas of responsibility for review and/or action.

However, of all of the software utilized for providing information to the users, one of the most widely used and most complex is the Materials Requirements Planning (MRP) and Manufacturing Resource Planning (MRP II) software. These modules were developed decades ago and are still in use today, with minor modifications, in almost every business and governmental entity worldwide. The fundamental questions that MRP answer are:

a. what materials, goods or supplies are needed;

b. when are they needed; and

c. how much is needed? MRP II, in addition to many other things, answers the question of what is the proper order to run the jobs in.

A brief overview of how MRP and MRP II works follows. MRP is basically a means for determining what materials will be needed, how much will be needed and when they will be needed. To do this, MRP looks at the historical usage of finished goods, components parts and/or raw materials. MRP also looks at the existing and forecasted sales and breaks that information down into the finished goods, component parts and/or raw material requirements. MRP then looks at the available on-hand and on-order inventory of finished goods, component parts and/or raw materials. Based upon the historical, existing and forecasted usage, the current and expected on-hand supplies and the expected lead-times to receive material, MRP provides a list of the goods and materials that will be required, when those goods and materials will be required and the quantity of goods and/or materials needed.

MRP II is basically a means for effectively scheduling the materials, machines and/or people to run the various jobs required to meet the company's and/or the customers' requirements. To do this, MRP II looks at the historical usage of finished goods, component parts and/or raw materials. MRP II also looks at the existing and forecasted sales and breaks that information down into the finished goods, component parts and/or raw material requirements. MRP II then looks at the available on-hand and on-order inventory of finished goods, component parts and/or raw materials. Based upon the historical, existing and forecasted usage and the current and expected on-hand supplies, MRP II creates a list of the finished goods, component parts and/raw material requirements.

MRP II then looks at the current status of work-in-progress and, based upon the availability of material and upon the required job routings, then schedules the work to be run on the routed equipment. The order of scheduling the work is done based upon getting the oldest in-house order out first.

When MRP and MRP II were developed, the primary driver for most business decisions was to reduce or contain costs. To that end, the developers of MRP created what is known as the Economic Order Quantity (EOQ). The EOQ answers the question of how much is needed to be ordered or how much is needed to be scheduled to run at the lowest total cost. The EOQ is a means for minimizing the costs associated with the making, purchasing and/or carrying goods in inventory.

For MRP and the EOQ for purchasing purposes, if the lead-times to receive the goods are the next day and the cost for placing an order is very small, then the EOQ would be only what is required for actual sales since the company is operating in a Just-in-Time (JIT) environment. However, if the lead-times are greater than one day, then the purchasing EOQ needs to cover the amount of goods required for existing orders plus the amount of goods expected to be consumed in future orders over the length of time for the expected supplier lead-time, plus any safety stock desired.

Having additional material on-hand, which is not immediately sellable, has some advantages and disadvantages. The primary advantage is that the on-hand material is immediately available for customers on demand. The disadvantage is that there is a carrying cost associated with having material on-hand that is not immediately sellable. Many distributors use a carrying cost of 30% to 40% per year as the cost of carrying excess inventory. Most manufacturers use the current financial interest rate of around 7% or 8% as the cost of carrying inventory. In addition, carrying excess material can result in spoilage or obsolescence of the excess material, resulting in additional costs for scrap and/or rework.

For manufacturing and MRP II, the EOQ is determined by balancing the costs associated with setting up and running a job against the cost of carrying the excess material over time at a predetermined interest rate. This method assures the lowest overall costs by not running so many parts as to incur excessive carrying costs and by not running too few parts so as to incur additional setup and running costs at a future date. Obviously, if a company can reduce the setup and running costs, then the EOQ is smaller and the carrying costs are less as well.

There have been alternatives and modifications to the use of the EOQ over the years. Some of the more common are:

a. EOQ with variations, for example EOQ plus backorders, EOQ plus safety stock, EOQ minus on-hand, etc.;

b. Actual requirements only;

c. Actual requirements plus additional parts for setup and processing;

d. Part period lot sizes (which looks at the annual usage and divides that by some arbitrary time period such as a month);

e. Vendor packaged quantities; and

f. Maximum desired inventory minus minimum desired inventory.

In addition to this, some of these methods take into account the desire for achieving a specified service level on specific products. The traditional A, B, C inventory classification can be used with the above methods resulting in increased inventory and, possibly, to the calculated order and/or lot sizes. However, the use of the traditional EOQ has been in use for decades and is still the primary and most widely used method for determining the order quantities for both purchasing and manufacturing in most entities.

The use of EOQ's for determining the amount of goods to order and/or produce are well known and wide spread. As a means for maintaining or reducing costs they are effective. However, if a company's primary strategic direction is something other than reducing costs, then the use of EOQ's to determine purchasing or production quantities is not only inconsistent with the strategic objectives, but may well be hindering the achievement of the strategic objective.

Twenty years ago, cost control was a significant and vital part of any business entity's strategic plans. However, with the advent of international trade agreements such as NAFTA, the shift to the globalization of business and work, and the changes brought on by improvements in telecommunications, internet business and new technology, many businesses have had to significantly change their strategic plans to accommodate for the changed business and competitive structures. That change has continued and will continue, forcing organizations to continually adapt and change their business strategies.

For example, in the United States a manufacturer or distributor today may be paying $15.00 to $25.00 or more per hour for a laborer, while in China that same laborer is getting paid less than $1.00 per hour. Obviously, given the wage rate, it is very unlikely that a United States company can compete with an identical company located in China on costs. As a result, many companies have switched their primary strategic focus from cost reduction to some other strategic advantage.

For example, one such switch was for companies to focus on reducing quality problems. Another switch was to focus on reducing lead-times to customers without adding inventory. Another switch was to strategically focus on improving profitability. These and many other strategic direction changes have significantly changed how business is operating and what they are pursuing in order to survive and grow their businesses.

However, for all of these changes and redirections of a company's strategic plan and focus, the IMS underlying the daily activity of the business has remained virtually unchanged. MRP and MRP II are unchanged and the use of EOQ is still being applied to keep costs low and drive the daily decisions on how many goods should be ordered or produced even when the primary strategic direction is something other than keeping costs low. In fact, the use of an EOQ when a company's strategic direction is something other than lowering costs many actually be hindering the company's efforts to achieve their strategic objective.

A technical problem in connection with strategic planning and operational activities is that there is no knowledge of an effective means for determining the optimal order and/or lot sizes for purchasing or production purposes that optimizes the lot sizes to be consistent with and supportive of the strategic objective of an entity. Furthermore, there is no technical way of evaluating any existing or proposed changes to order and/or lot sizes to determine how those order and/or lot size changes impact the strategic objective of an entity with the sole exception of cost control, which is currently the only means in place for determining order and/or lot sizes. Therefore, a need exists for a means that allows an entity to determine the ordering and/or production lot sizes that are consistent with the entity's strategic objective, when the entity's strategic objective is not the maintenance or reduction of costs.

### BEST MODE FOR CARRYING OUT THE INVENTION

To facilitate the description of the invention, it is worthwhile to define some terminology solely for this purpose. This terminology is somewhat arbitrary and should not be construed as limiting the generality of the invention. For the purposes of this description:

1. Lot sizes and order quantities are meant to include purchase order quantities, production order quantities, lot sizes and/or any terminology that is used to define the quantities required for a given operation.

2. Planning period is a time frame meant to include the existing orders or work schedule, however the planning period could also use or include the current forecastable planning period and/or any other planning period, including a historical planning period, chosen by the user.

3. Entity is meant to include any profit or non-profit business including academics, governmental, charity and/or any other endeavor.

4. Strategic objective are meant to include any and all desired goals, end results, improvements and/or directions that the entity, as a whole, desires to move toward and/or achieve. Strategic objective is meant to include both the singular and plural sense of the word.

Reference will now be made in detail to the description of the invention as illustrated in the appended drawings. Although the invention will be described in connection with these drawings, there is no intent to limit the invention to the embodiment or embodiments disclosed therein. On the contrary, the intent is to include all alternatives, modifications and equivalents included within the spirit and scope of the invention as defined by the appended claims.

Furthermore, the order of the itemized steps in FIG. 2 are not meant to limit the scope of the invention to the specific itemized order of those steps, but rather to include those steps in any relevant order including any alternatives, modifications and equivalents included within the spirit and scope of the invention as defined by the appended claims.

To aid in the understanding of the invention, examples of some of the specific itemized steps are provided for clarification purposes only. These examples are not meant to limit the invention to the process of developing order quantities and/or lot sizes or only to businesses, but rather to include determining order sizes and/or lot sizes of any scope for any entity including any alternative, modification and equivalents included within the spirit and scope of the invention as defined by the appended claims.

FIG. 1 illustrates a system for determining the appropriate lot sizes or order quantities to be consistent with the strategic objective of an organization in accordance with the present invention. The apparatus 12 used to determine the appropriate order quantities and/or lot sizes may be embodied in any computing device, such as a personal computer or work station, as modified to carry out the features and functions of the present invention. As shown in FIG. 1, the system contains a processor 13, such as a central processing unit (CPU), and memory 14, such as RAM and ROM. Stored in the memory 14 are databases 15 and the Management Information System (MIS) 16. Within the MIS 16 are a variety of software programs including a Materials Requirement Planning (MRP) 17 module and Manufacturing Resource Planning (MRP II) 18 module.

In an alternative embodiment, multiple computing devices could be utilized to host and accomplish whole parts, or individual portions, of the processor 13, memory 14, and/or MIS 16 software.

As shown in FIG. 2, the process for determining the appropriate order and/or lot size for a given job starts with establishing the strategic objectives 1 for the organization. In its preferred embodiment, once the strategic objectives 1 are defined, the organization's strategic objectives 1 are prioritized 2 and a primary strategic objective 3 identified. Following the determination of the primary strategic objective 3 a list of possible measures 4 for the primary strategic objective 3 are developed and the primary measure 5 for the primary strategic objective 3 is selected.

It is important to prioritize 2 and select the primary the strategic objective 3 as different strategic objectives 1 may have different and/or conflicting measures. For example, if there were two strategic objectives 1, one to improve profitability and another to reduce product lead-times, the measure for improving profits might be something like monitoring the earnings before income taxes (EBIT) while the measure for reducing lead-times might be something like monitoring the average lead-time per customer order. If the primary strategic objective 3 was selected to be reducing lead-times, it is possible that the actions taken could reduce lead-times and improve EBIT. However, it is just as possible that the actions taken to reduce lead-times, say by increasing available on-hand inventory, could reduce the EBIT. As such, it is important to this invention that the strategic objectives 1 be prioritized 2 and the primary strategic objective 3 selected.

In a similar fashion, choosing the appropriate measure for the primary strategic objective 3 is important to this invention. For example, if a primary strategic objective 3 is to improve profitability, there are a wide variety of measures that could be selected as the primary measure. Those measures could be such things as earnings before income taxes (EBIT), dollars of gross profit, dollars of net profit, percent gross margin, percent net margin, return on investment (ROI), average dollar profit per customer or per product line, or a host of other possible measures. Clearly, these differing measures could show conflicting results. For example, if the number of customers fell significantly but the remaining customers purchased higher margin products, then the average profit per customer could show an increase even though the total EBIT and the dollars of net and gross profit fell.

As a result, it is important to this invention and to the users that great care is taken in determining the primary strategic objective 3 and the corresponding primary strategic objective measure 5. Choosing the wrong primary strategic objective 3 and/or the wrong primary strategic measure 5 may result in achieving unintended consequences.

However, once the primary strategic objective 3 and its corresponding measure 5 are selected, the next step is to run the MIS 16, MRP 17 and/or MRP II 18 programs as if the jobs currently scheduled for work were in fact ordered and/or run and completed per the existing schedule and the existing ordering rules (test run 1) 6. The test run 1 6 is run for the time frame selected for the planning period. The planning period could be for the existing orders only, for the forecastable future orders or for any other time frame selected by the user. Following this, the process uses the MIS software 16 and the outputs from the test run 1 6 to calculate the expected results (ER1) 7 based upon the primary strategic objective measure 5.

The next step is to return to the existing MIS 16, MRP 17 and/or MRP II 18 programs and the currently scheduled work, remove one of the scheduled jobs (job A) from the work list and re-run the MIS 16, MRP 17 and/or MRP 11 18 programs as if the remaining jobs were ordered and/or run per the schedule and existing ordering rules (test run 2) 8. Test run 2 8 should be run over the same time frame, or planning period, that was used during test run 1 6. The process then uses the MIS software 16 and the new outputs from test run 2 8 to calculate the new expected results (ER2) 9 based upon the primary strategic objective measure 5. The process then takes the first expected results (ER1) 7 and subtracts the second expected results (ER2) 9 to find the difference 10. The difference 10 is the amount of impact that the job removed from the schedule (job A) has on the primary strategic objective measure 5.

For example, if the primary strategic objective 3 was to reduce lead-times and the primary strategic objective measure 5 was average lead-time per customer order, the MIS 16, MRP 17 and/or MRP II 18 could be run with the assumption that the existing jobs were run and shipped per the existing schedule and ordering rules. From the expected results, the average expected lead-times per customer could be calculated or forecasted. Then, by removing one product line from all of the existing orders and re-running the MIS 16, MRP 17 and MRP II 18 programs, a new average expected lead-time per customer could be calculated.

Subtracting the new average expected lead-time per customer from the average expected lead-time per customer results in the amount of lead-time created by the job that was removed (job A) over the planning period.

The similar result is arrived at regardless of the chosen primary strategic objective 3 and the primary strategic objective measure 5. If the primary strategic objective 3 and measure 5 is EBIT, or sales dollars, or increased unit volume or any other strategic objective 3 and measure 5, then the calculated difference 10 is the amount of impact that a specific job (job A) has on the primary strategic objective 3, as measured by the primary strategic objective measure 5.

In the event that the difference 10 results in a negative number, then the user has three possible alternatives. The first alternative is to reset the planning period to a different or longer time frame, and to re-do the current schedule at test run 1 6 and continue from there forward with the process. Another alternative is to simply set the lot and/or order sizes at the required quantity only. The third alternative is to use some other means, such as the traditional EOQ method, for determining the lot and/or order size. However, if the second or third alternative is used, then the lot and/or order sizes will not be consistent with the primary strategic objective. These quantities can be modified to account for spoilage, scrap and/or other contingencies if desired.

In order to determine the appropriate order and/or lot size 11 to order and/or run for a given job (job A) that is synchronous and consistent with the primary strategic objective 3 and measure 5, the process then takes the calculated difference 10 and subtracts any fixed amount associated with the job (job A) in the same measure as the primary strategic objective measure 5 and divides the difference by the amount per unit or piece of the job (job A) that is measured in the same means as the primary strategic objective measure 5. Using the same lead-time example as above, if the primary strategic objective 3 is to reduce lead-times and the primary measure 5 is average lead-time per customer, the amount of lead-time created by a specific job (job A) is determined by following the processing steps 6, 7, 8, 9, and 10. By then subtracting the amount of time required to setup the job from the difference 10 and dividing that result by the routed run time per piece, the result would be the order and/or run size 11, that balances the amount of lead-time created by the specific job (job A) with the amount of time required to setup and run the job (job A).

Similarly, if the primary strategic objective 3 and measure 5 is EBIT the amount of EBIT created by a specific job (job A) can be calculated by following the processing steps 6, 7, 8, 9, and 10. By then subtracting the cost associated with ordering and/or setting up the job (job A) from the difference 10 and dividing the result by the amount of EBIT attributable to one unit of the specific job (job A), the appropriate lot size to order and/or run that is consistent and supportive of the primary strategic objective 3 to increase EBIT is arrived at.

The process from steps 6, 7, 8, 9, 10 and 11 are then iterated over again for each and every other job (jobs B, C, D, etc.) until the entire job list has recalculated all of the new lot sizes for each job. The same approach can be utilized for any chosen primary strategic objective. The result being a lot size 11 determination that is consistent and supportive of the primary strategic objective of the business created by balancing the impact a given job has on the primary strategic objective 3 with the measure related to an individual unit of the specific job.

In an alternate form, once the newly created lot sizes have been calculated, the actual required quantities or some other designated quantity can be added to the calculated lot size to create a modified lot size for a specific job. In another alternative, the newly created lot sizes can be reduced or restricted if failing to do so would create a possibility of spoilage or other unacceptable result such as too much on-hand inventory or other constraint.

It is to be understood that the embodiments and variations shown and described herein are merely illustrative of the principles of this invention and that various modifications may be implemented by those skilled in the art without departing from the scope and spirit of this invention. The spirit of the invention is to establish a means for aligning a entity's order quantities and/or lot sizes which the entity purchases or produces with its primary strategic objective such that the operational side of the entity is supporting and consistent with the strategic direction of the entity.

I claim:

### BRIEF DESCRIPTION OF THE DRAWINGS

For a further understanding of the nature and objects of the invention, reference should be made to the following description and appended claims, taken in conjunction with the accompanying drawings, in which like elements are given the same reference numbers. It is to be understood that these drawings depict only the typical embodiments of the invention and are, therefore, not to be construed as limiting the scope and spirit of the invention.

FIG. 1 illustrates an overall system in accordance with the present invention; and

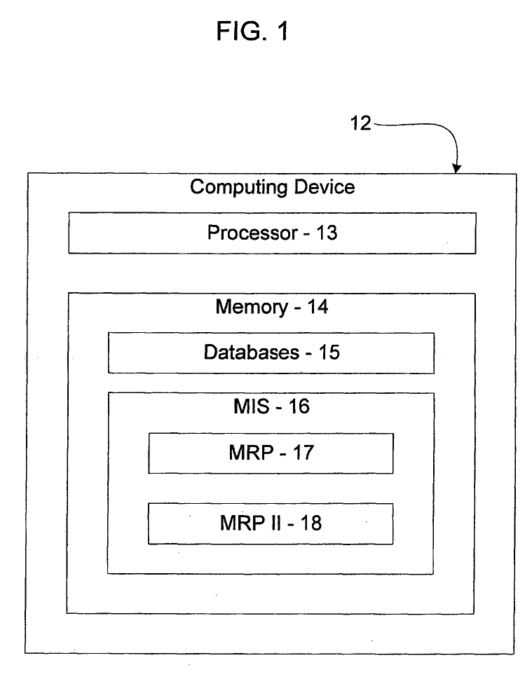

FIG. 2 is a flow chart describing an exemplary order and/or lot size determination process.

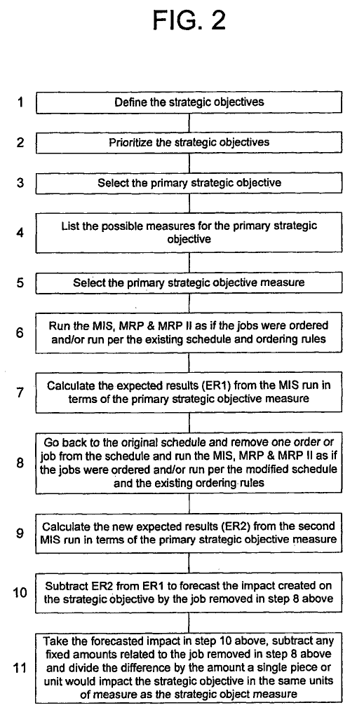

I claim:

1. a method for determining order and/or lot sizes that are consistent with an entity's primary strategic objective, comprising the steps of:
a. selecting a primary strategic objective;
b. listing the possible strategic objective measures;
c. selecting the primary strategic objective measure and calculation;
d. running the MRP, MRP II and any other MIS for a planning period as if the currently required activities and/or work were in fact already ordered and/or run per the existing activity schedule and ordering rules;
e. determining the first expected results ran in step d as measured in terms of the said primary strategic objective measure calculation;
f. temporarily modifying the said existing activity schedule by removing one of the said currently required activities or work in the said existing activity schedule and re-running the said MRP, MRP II and any other MIS for the said planning period as if the remaining activities and/or work were in fact already run per the said existing activity schedule and the said existing ordering rules;
g. determining the second expected results of the said modified activity schedule created in step f as measured in terms of the said primary strategic objective measure calculation;
h. taking the said first expected results found in step e and subtracting the said second expected results found in step g to determine the impact of the said activity and/or work that was removed in step f on the said strategic objective measure;
i. determining the appropriate new order and/or lot size that is consistent with the said primary strategic objective by taking the said impact found in step h and subtracting any fixed amount associated with the said activity or work that was removed in step f in the same units of measure as the said primary strategic objective measure and then dividing the result by the amount per unit or piece of the said removed job, the said amount is measured in the same unit of measure as the said primary strategic objective measure; and
j. re-running steps d through i above for each different job and/or order existing.

2. The method of claim 1, wherein the said new order and/or lot size includes adding an additional quantity to the said new order and/or lot size.

3. The method of claim 1, wherein the said new order and/or lot size includes an upper limiting value that is not to be exceeded.

4. The method of claim 1, wherein the said new order and/or lot size is over-ridden and a substitute value put in for the said new order and/or lot size.

5. The method of claim 2, wherein the said new order and/or lot size includes an upper limiting value that is not to be exceeded.

6. The method as in any one of claims 1 through 5, wherein the said primary strategic objective is any strategic objective.

7. An apparatus for determining an entity's order and/or lot sizes that the entity purchases and/or produces consistent with and supportive of the entity's primary strategic objective such that the operational side of the entity is supporting and consistent with the said strategic direction of the entity, wherein said apparatus includes:
a. user interface devices and modules operatively coupled to said apparatus;
b. a memory that stores databases and computer readable code;
c. said databases including original databases and modified original databases;
d. a processor operatively coupled to said memory, said processor configured to implement said computer readable code, said code configured to:
i. receive, load and store the calculations for the primary strategic objective measure in the said memory or storage medium of the said apparatus;
ii. modify the existing planned activities or work not yet completed to be temporarily assumed to be completed over a planning period and temporarily store the said activity that is assumed completed in the said modified original databases in the said memory or storage medium of the apparatus;
iii. execute the MRP, MRP II and any other MIS program(s) for the said planning period using the said modified original databases per the existing schedule and ordering rules;
iv. determining the first expected results of the programs ran in step iii as measured by the said primary strategic objective measure calculation and store the said first expected results in the said memory or storage medium of the said apparatus;
v. temporarily remove one of the said activities or work in the said modified original databases in the said memory or storage medium of the said apparatus and re-running the said MRP, MRP II and any other MIS program(s) for the said planning period as if the remaining said activities and/or work were in fact already run per the modified original databases list and the said existing ordering rules;
vi. determining the second expected results of the said programs ran in step v as measured in terms of the said primary strategic objective measure calculation and store the said first expected results in the said memory or storage medium of the said apparatus;
vii. taking the said first expected results found in step iv and subtracting the said second expected results found in step vi to determine the impact of the said activity and/or work that was removed in step v on the said strategic objective measure;
viii. determining the appropriate new order and/or lot size that is consistent with the said primary strategic objective by taking the said impact found in step vii and subtracting any fixed amount associated with the said job that was removed in step v in the same units of measure as the said primary strategic objective measure and then dividing the result by the amount per unit or piece, in the same units of measure as the said primary strategic objective measure, of the said job that was removed wherein the said amount is measured in the same unit of measure as the said primary strategic objective measure;
ix. re-storing the said removed activity or work into the said modified database with the new said order and/or lot size and storing the new order and/or lot size into the said original database in the said memory or storage medium of the said apparatus; and
x. re-running steps v through ix above for each different activity and/or work currently planned in the planning period.

8. An apparatus as recited in claim 7, wherein the said code is configured to add and additional quantity to the said new order and/or lot size.

9. An apparatus as recited in claim 7, wherein the said code is configured so that the said new order and/or lot size has an upper limiting value that is not to be exceeded.

10. An apparatus as recited in claim 7, wherein the said code is configured to over-ride the said new order and/or lot size with a substitute value.

11. An apparatus as recited in claim 8, wherein the said code is configured so that the said new order and/or lot size has an upper limiting value that is not to be exceeded.

12. An apparatus as in any one of claims recited in claim 7 through 11, wherein the said primary strategic objective is any strategic objective.

13. A computer program embodied on a computer-readable medium for determining an order and/or lot size that the entity purchases and/or produces consistent with and supportive of the entity's primary strategic objective such that the operational side of the entity is supporting and consistent with the said strategic direction of the entity, wherein said determination comprises a data structure instantiating code segment that establishes a storage record in memory having:
a. the calculations for the primary strategic objective measure;
b. a first expected results of the existing activities and/or work as measured by the said primary strategic objective measure calculation calculated over a planning period as if the said existing activities and/or work were already completed;
c. a second expected results of the existing activities and/or work, less one of the said existing activities, as measured by the said primary strategic objective measure calculation calculated over a planning period as if the said existing remaining activities and/or work were already completed;
d. the difference between the said first expected results and the said second expected results; and
e. the new order and/or lot size as determined by taking the said difference and subtracting any fixed amount associated with the said removed job and dividing the result by any amount per piece or unit, wherein all said amounts are in the same units of measure as the said primary strategic objective measure.

14. A computer program embodied on a computer-readable medium as recited in claim 13, wherein the said new order and/or lot size comprises a data structure instantiating code segment that establishes a storage record in memory having an additional quantity added to the said new order and/or lot size.

15. A computer program embodied on a computer-readable medium as recited in claim 13, wherein the said new order and/or lot size comprises a data structure instantiating code segment that establishes a storage record in memory having an upper limiting value that the said new order and/or lot size is not to exceed.

16. A computer program embodied on a computer-readable medium as recited in claim 13, wherein the said new order and/or lot size comprises a data structure instantiating code segment that establishes a storage record in memory wherein the said new order and/or lot size is over-ridden with a substitute value.

17. A computer program embodied on a computer-readable medium as recited in claim 14, wherein the said new order and/or lot size comprises a data structure instantiating code segment that establishes a storage record in memory having an upper limiting value that the said new order and/or lot size is not to exceed.

18. A computer program embodied on a computer-readable medium as in any one of claims 13 through 17, wherein the said primary strategic objective is any strategic objective.

19. A device and system for determining an entity's order and/or lot sizes that the entity purchases and/or produces consistent with and supportive of the entity's strategic objective, said device and system comprising:
a. a means for receiving, loading and storing the calculations for the primary strategic objective measure in the said memory or storage medium of the said device;
b. a means for modifying the existing planned activities or work not yet completed to be temporarily assumed to be completed over a planning period and temporarily store the said activity that is assumed completed in the said modified original databases in the said memory or storage medium of the device;
c. an means for executing the MRP, MRP II and any other MIS program(s) for the said planning period using the said modified original databases per the existing schedule and ordering rules;
d. a means for determining the first expected results of the programs ran in step c as measured by the said primary strategic objective measure calculation and store the said first expected results in the said memory or storage medium of the said device;
e. a means for temporarily remove one of the said activities or work in the said modified original databases in the said memory or storage medium of the said device and re-running the said MRP, MRP II and any other MIS program(s) for the said planning period as if the remaining said activities and/or work were in fact already run per the modified original databases list and the said existing ordering rules;
f. a means for determining the second expected results of the said programs ran in step e as measured in terms of the said primary strategic objective measure calculation and store the said first expected results in the said memory or storage medium of the said device;
g. a means for taking the said first expected results found in step id and subtracting the said second expected results found in step f to determine the impact of the said activity and/or work that was removed in step e on the said strategic objective measure;
h. a means for determining the appropriate new order and/or lot size that is consistent with the said primary strategic objective by taking the said impact found in step g and subtracting any fixed amount associated with the said job that was removed in step e in the same units of measure as the said primary strategic objective measure and then dividing the result by the amount per unit or piece, in the same units of measure as the said primary strategic objective measure, of the said job that was removed wherein the said amount is measured in the same unit of measure as the said primary strategic objective measure;
i. a means for re-storing the said removed activity or work into the said modified database with the new said order and/or lot size and storing the new order and/or lot size into the said original database in the said memory or storage medium of the said device; and
j. a means for re-running steps e through i above for each different activity and/or work currently planned in the planning period.

20. The means of claim 19, wherein said means includes additional means for adding an additional quantity to the said determined order and/or lot sizes.

21. The means of claim 19, wherein said means includes additional means for establishing an upper limit on the said determined order and/or lot sizes that is not to be exceeded.

22. The means of claim 19, wherein said means includes additional means for over-riding the said determined order and/or lot sizes with a substitute value.

23. The means of claim 20, wherein said means includes additional means for establishing an upper limit on the said determined order and/or lot sizes that is not to be exceeded.

24. The means as in any one of claims 19 through 23, wherein the said primary strategic objective is any strategic objective.
